(19) United States
(12) Patent Application Publication
(10) Pub. No.: US 2018/0113735 A1
(43) Pub. Date: Apr. 26, 2018

(54) LAUNCH METHOD FOR APPLICATIONS WITH EARLY-TIME MEMORY RECLAIM AND ELECTRONIC DEVICE

(71) Applicant: MEDIATEK INC., Hsin-Chu (TW)

(72) Inventor: Yu-Lung LU, Hsin-Chu (TW)

(21) Appl. No.: 15/698,761

(22) Filed: Sep. 8, 2017

Related U.S. Application Data
(60) Provisional application No. 62/410,870, filed on Oct. 21, 2016.

(51) Int. Cl. G06F 9/48; G06F 9/50

(52) U.S. Cl. CPC G06F 9/4806; G06F 9/485; G06F 2209/482; G06F 2209/503; G06F 9/5016

(57) ABSTRACT

A launch method and an electronic device are provided. The electronic device includes a first memory, a first memory controller, and a first processor. The first memory controller is coupled to the first memory. According to the launch method, the first processor executes the launch program to receive a signal indicating that a first application is to be launched, notify a background service to prepare memory space of the first memory for launch of the first application in response to the received signal, and launch the first application after notifying the background service to prepare the memory space of the first memory.

### CROSS REFERENCE TO RELATED APPLICATIONS

This application claims the benefit of U.S. Provisional Application No. 62/410,870, filed on Oct. 21, 2016, the contents of which are incorporated herein by reference.

### BACKGROUND OF THE INVENTION

### Field of the Invention

The invention relates to a launch method for applications, and more particularly to a launch method on an electronic device with early-time memory reclaim.

### Description of the Related Art

Generally, electronic devices, such as smart phones, tablet computers, and notebooks, and other computing devices, can execute various applications. When a request is transmitted to indicate that an application will be executed, the application is launched in response to the request. When the application is launched, at least one process is executed through accessing a volatile memory, such as a random access memory (RAM). If the available space of the volatile memory is not sufficient for the launch of the application, the launch of the application has to be interrupted until the memory is reclaimed to have sufficient space. Thus, the period of waiting for the memory reclaim increases the launch time of the application, which results in worse user experience.

### BRIEF SUMMARY OF THE INVENTION

An exemplary embodiment of a launch method for a first application on an electronic device when a launch program is loaded and executed by a first processor is provided. The launch method comprises the steps of receiving a signal indicating that the first application is to be launched; notifying a background service to prepare memory space of a first memory for launch of the first application in response to the received signal; and launching the first application after notifying the background service to prepare the memory space of the first memory.

An exemplary embodiment of an electronic device is provided. The electronic device comprises a first memory, a first memory controller, and a first processor. The first memory controller is coupled to the first memory. The first processor executes the launch program to receive a signal indicating that a first application is to be launched, notify a background service to prepare memory space of the first memory for launch of the first application in response to the received signal, and launch the first application after notifying the background service to prepare the memory space of the first memory.

Another exemplary embodiment of a launch method for an application on an electronic device when a launch program is loaded and executed by a first processor is provided. The launch method comprises the steps of notifying a background service to prepare memory space of a memory for launch of the application, launching the application by accessing the prepared memory space of the memory; obtaining space of the memory occupied for the launch of the application; and updating history usage space for the launch of the application according to the obtained space of the memory occupied for the launch of the application.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows one exemplary embodiment of an electronic device;

FIG. 2A shows a flow chart of one exemplary embodiment of a launch method for an application to be run by a processor;

FIG. 2B shows a flow chart of another exemplary embodiment of a launch method for an application to be run by a processor;

FIG. 3A is flow chart showing how a background service prepares memory space of a volatile memory for launch of an application according to one exemplary embodiment;

FIG. 3B is flow chart showing how a background service prepares memory space of a volatile memory for launch of an application according to another exemplary embodiment;

FIG. 4A shows a flow chart of another exemplary embodiment of a launch method for an application; and

FIG. 4B shows a flow chart of further another exemplary embodiment of a launch method for an application; and

FIG. 5 shows another exemplary embodiment of an electronic device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

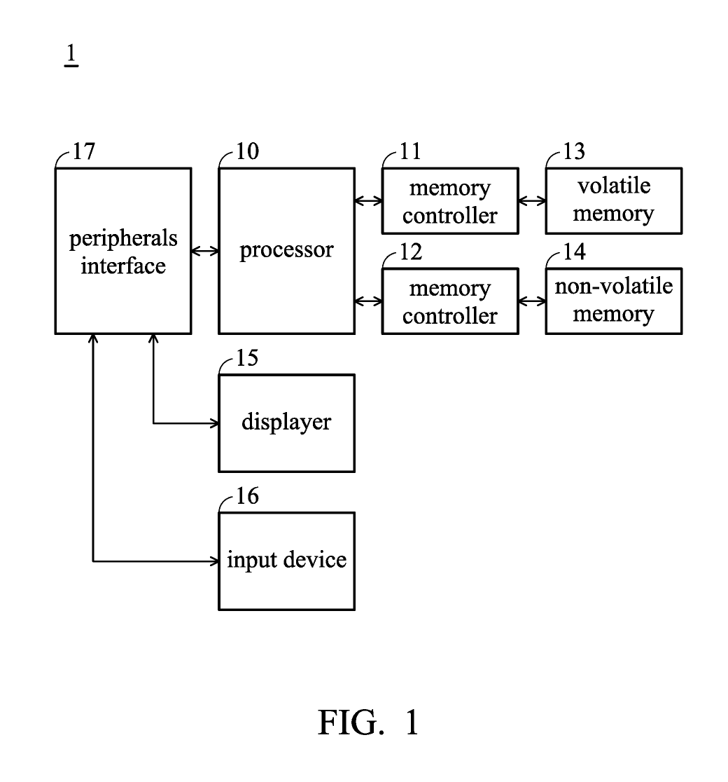

FIG. 1 shows an exemplary embodiment of an electronic device. Referring to FIG. 1, the electronic device 1 comprises a processor 10, memory controllers 11 and 12, a volatile memory 13, a non-volatile memory 14, a displayer 15, an input device 16, and a peripheral interface 17. The electronic device 1 may be any of variety of devices, such as a smart phone, a netbook, a tablet computer, a digital media player, a book reader, or any combination thereof. The memory controllers 11 and 12 are controlled by the processor 10. The volatile memory 13 may be a random access memory (RAM), while the non-volatile memory 14 may be a read-only memory (ROM), a hard disc drive, or a flash memory. The memory controller 11 operates for managing the volatile memory 13 in response to instructions sent from the processor 10. The memory controller 12 operates for managing the non-volatile memory 14 in response to instructions sent from the processor 10. The processor 10 operates to run an operation system and various applications. The data and program codes for the operation system and the application are stored in the non-volatile memory 14. When a program including a set of program codes is loaded into the volatile memory 13 and executed by the processor 10, the processor 10 runs the operating system and/or a corresponding application to provide various functionalities of the electronic device 1.

In the embodiment, the operating system is Android by Google. In another embodiment, the operation system is OS X by Apple Inc. Peripheral devices, such as the displayer 15 and the input device 16, are coupled to the processor 10 through the peripheral interface 17 to facilitate the functionalities of the electronic device 1 when the processor 10 runs the operating system and/or at least one application. The input device 16 comprises a physical keyboard, a mouse, a touch panel disposed on the displayer 15, or any combination thereof.

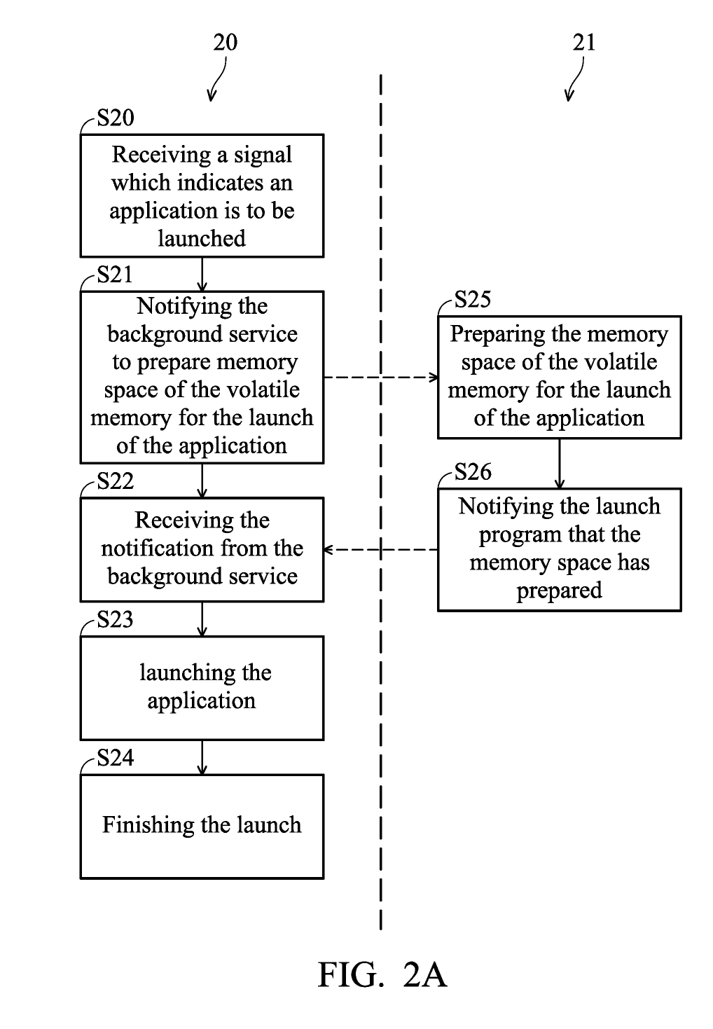

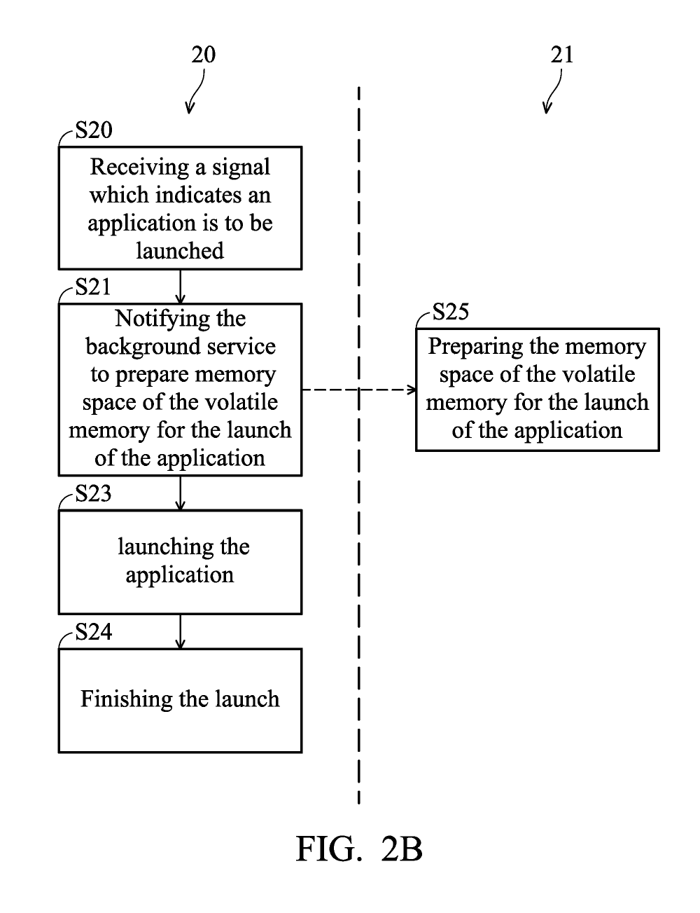

FIG. 2A shows a flow chart of an exemplary embodiment of a launch method for an application. Referring to FIGS. 1 and 2A, a launch program 20 is loaded into the volatile memory 13 from the non-volatile memory 14 and executed by the processor 10 in background. The launch method of the embodiment shown in FIG. 2A is achieved by executing the launch program 20 and a background service 21 by the processor 10, wherein the background service is also known as “daemon” in this technology field. In the embodiment, the background service 21 is a computer program which runs as a background process, rather than being under the direct control of an interactive user. When the launch program 20 receives a signal which indicates an application is to be launched (step S20), the launch program 20 notifies the background service 21 to prepare memory space of the volatile memory 13 for the launch of the application (step S21). In the embodiment, the signal receiving in the step S20 is generated in response to clicking the icon of the application shown on the displayer 15 by a user through the input device 16. At this time, the launch program 20 waits for a notification from the background service 21.

After the background service 21 receives the notification from the launch program 20, the background service 21 prepares the memory space of the volatile memory 13 for the launch of the application (step S25). When the prepared memory space of the volatile memory 13 is sufficient to the whole procedure of the launch of the application, the preparation of the memory space of the volatile memory 13 for the launch of the application is done, and the background service 21 notifies the launch program 20 that the memory space has prepared by transmitting a notification (step S26). After the launch program 20 receives the notification from the background service 21 (step S22), the launch program 20 launches the application by accessing the prepared memory space of the volatile memory 13 (step S23). When the launch of the application is finished (step S24), the processor 10 then executes the corresponding program codes to run the application. In the following, how the background service 21 prepares the memory space for the launch of the application will be described in the following paragraphs.

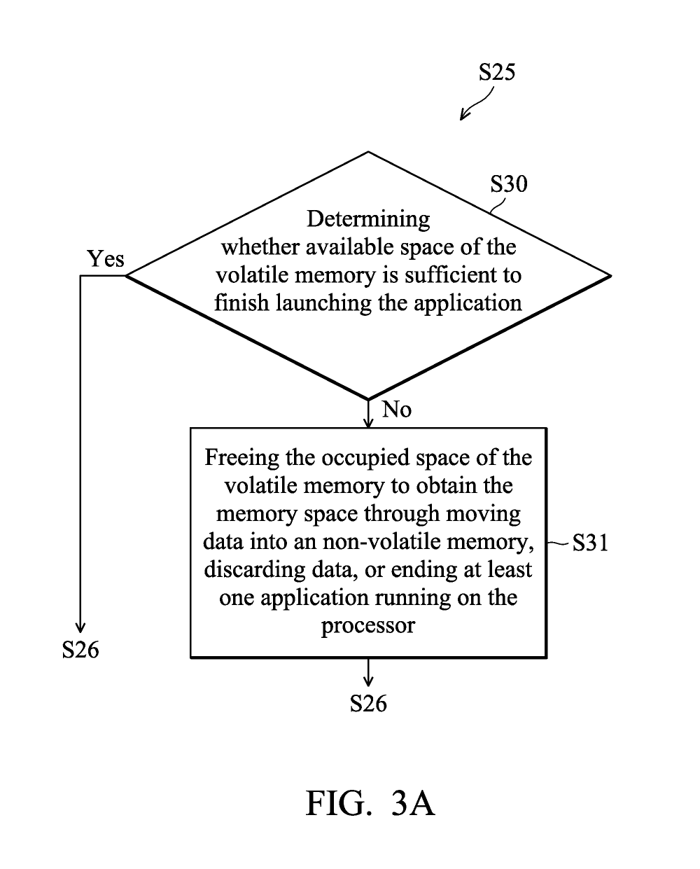

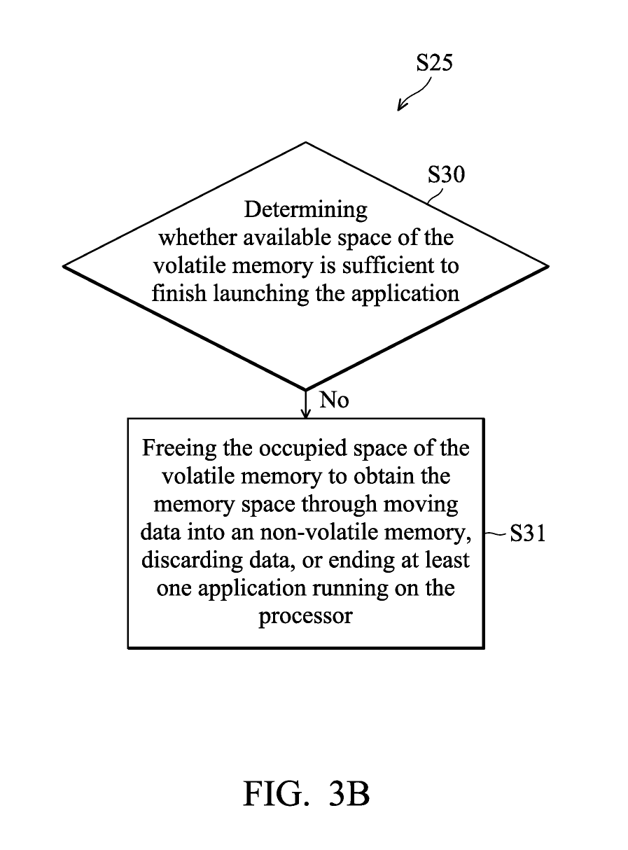

FIG. 3A is flow chart of the step 25 of preparing the memory space of the volatile memory 13 for the launch of the application by the background service 21. Referring to FIG. 3A, when the background service 21 enters the step S25, the background service 21 determines whether available space of the volatile memory 13 is sufficient to finish launching the application (step S30). When the background service 21 determines that the available space of the volatile memory 13 is not sufficient to finish launching the application (step S30-No), the background service 21 frees the occupied space of the volatile memory 13 to obtain the memory space of the volatile memory 13 thereby reclaiming the volatile memory 13 and preparing the memory space of the volatile memory 13 for the launch of the application (step S31).

In the embodiment, the occupied space of the volatile memory 13 is used to store the data accessed by another application or other applications which are running on the processor 10. When the occupied space of the volatile memory 13 is freed, the available space of the volatile memory 13 becomes larger. Accordingly, the available space of the volatile memory 13 becomes sufficient to finish launching the application, and the entire available space or a portion of the available space can serve as the memory space for the launch of the application. Then, the flow proceeds to the step S26 in which the background service 21 notifies the launch program 20 that the memory space has prepared. In other words, the background service 21 notifies the launch program 20 that the memory space is sufficient for the launch of the application. When the background service 21 determines that the available space of the volatile memory 13 is sufficient to finish launching the application (step S30—Yes), the entire available space or a portion of the available space serves as the memory space for the launch of the application. Then, the flow proceeds to the step S26 in which the background service 21 notifies the launch program 20 that the memory space has prepared.

In an embodiment, for the step S31, the occupied space of the volatile memory 13 is freed through moving the data stored in the volatile memory 13 for another application or other applications running on the processor 10 into the non-volatile memory 14 thereby reclaiming the volatile memory 13. In another embodiment, for the step S31, the occupied space of the volatile memory 13 is freed through discarding the data stored in the volatile memory 13 for another application or other applications running on the processor 10. In another embodiment, for the step S31, the occupied space of the volatile memory 13 is freed through ending (or killing) another application or other applications running on the processor 10).

In the step S25, the background service 21 may prepare the memory space of the volatile memory 13 for the launch of the application according to history data which is previously stored in the non-volatile memory 14. In an embodiment, the history data comprises the history usage space for the launch of the application. Thus, in the step S30, the background service 21 can compare the available space of the volatile memory 13 with the history usage space of the history data to determine whether the available space of the volatile memory 13 is sufficient to finish launching the application. In addition to the steps S20-S26 of FIG. 2A, the launch program 20 comprises steps for obtaining the above history data.

In the above embodiments shown in FIGS. 2A and 3A, after the launch program 20 receives the notification from the background service 21, the launch program 20 then launches the application. In another embodiment, after the launch program 20 notifies the background service 21 to prepare memory space of the volatile memory 13 for the launch of the application (step S21), the launch program 20 then launch the application (S23) without waiting the notification from the background service 21. As shown in FIG. 2B, the steps S22 and S26 are not performed anymore. Accordingly, while the background service 21 is freeing the occupied space of the volatile memory 13 for the launch of the application, the launch program 20 launches the application. In this case, after the background service 21 frees the occupied space of the volatile memory 13 (step S31) to prepare the memory space 13 for the launch of the application, the background service 21 does not need to enter the step S26, as shown in FIG. 3B.

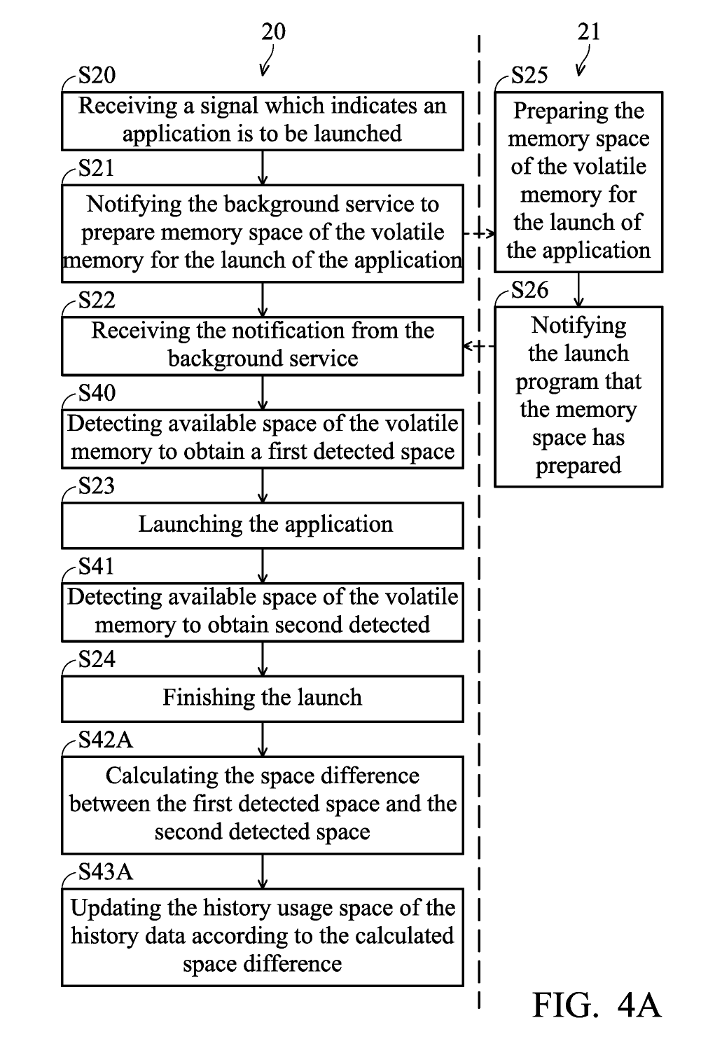

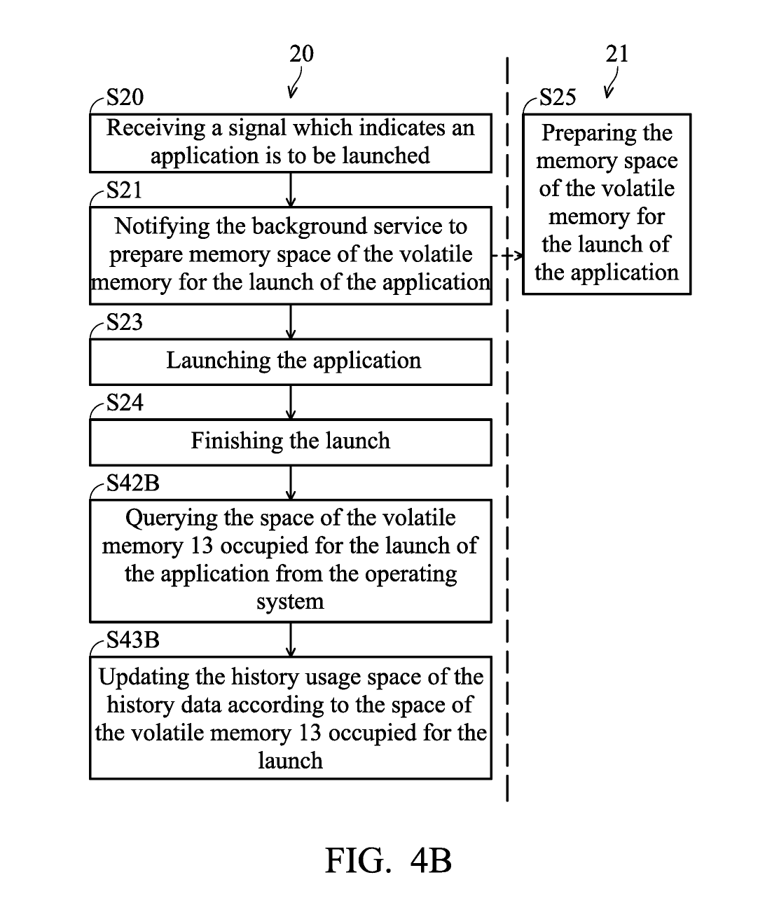

Referring to FIG. 4A, according to an embodiment, after the launch program 20 receives the notification which indicates that the memory space for the launch of the application has prepared from the background service 21 in the step S22, the launch program 20 detects currently available space of the volatile memory 13 to obtain a first detected space (step S40). The currently available space of the volatile memory is detected in the step S40 is the available space of the volatile memory 13 which is originally sufficient for the launch of the application (that is, the step S31 is not performed (step S30—Yes)) or the available space of the volatile memory 13 which is obtained through freeing the occupied space of the volatile memory 13 in the step S31 (step S30-No). During the launch of the application performed in the step S23, the available space of the volatile memory 13 changes or decreases. Thus, the launch program 20 detects currently available space of the volatile memory 13 after the launch of the application is finished in the step S24 to obtain second detected (step S41). After the first detected space and the second detected space is obtained, the launch program 20 calculates the space difference between the first detected space and the second detected space (step S42A). Thus, the space of the volatile memory 13 occupied for the launch of the application is obtained according to the calculated space difference. Then, the launch program 20 updates the history usage space of the history data stored in the non-volatile memory 14 according to the calculated space difference (step S43).

In another embodiment, the program 40 counts how many times the launch of the application is executed during a predetermined period. If the launch of the application is executed more than once during the predetermined period, the program 40 calculates the average of the space difference during the predetermined period and updates the history usage space of the history data stored in the non-volatile memory 14 according to the average of the space difference.

As described above, for the step S31, the occupied space of the volatile memory 13 may be freed through ending (or killing) another application or other applications running on the processor 10. In an embodiment, the ended application(s) is an application (or applications) with a lower priority value (or lower priority values) among the applications running on the processor 10. In another embodiment, the ended application(s) is an application (or applications) which is ended by more times in the past among the applications running on the processor 10.

In another embodiment, while the background service 21 is freeing the occupied space of the volatile memory 13 for the launch of the application, the launch program 20 launches the application. Thus, the background service 21 does not notify the launch program 20 that the memory space has prepared, and the launch program 20 does not receive any notification, which indicates that memory space has prepared, from the background service 21, as shown in FIG. 4B. In this case, referring to FIG. 4B, after the launch of the application is finished in the step S24, the launch program 20 queries the space of the volatile memory 13 occupied for the launch of the application from the operating system performed by the processor 10 (step S42B). Then, the launch program 20 updates the history usage space of the history data stored in the non-volatile memory 14 according to the obtained space of the volatile memory 13 occupied for the launch of the application (step S43B).

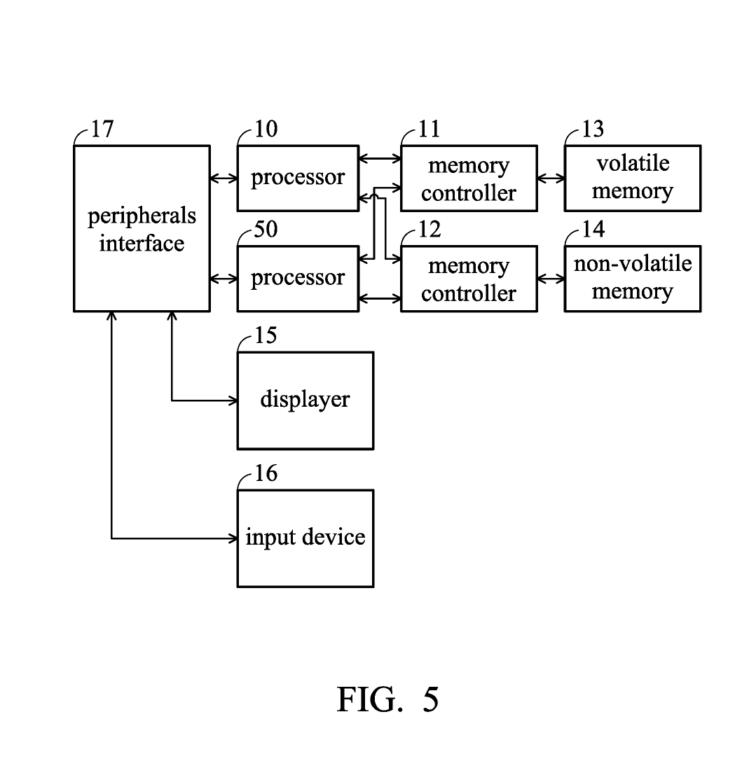

In the above embodiments, the background service 21 is executed by the processor 10. In another embodiment, the electronic device 1 is a device with two cores. As shown in FIG. 5, in addition to the processor 10, the electronic device 1 further comprises another processor 50. The memory controllers 11 and 12 are also controlled by the processor 50. The displayer 15 and the input device 16 are coupled to the processor 50 through the peripheral interface 17 to facilitate the functionalities of the electronic device 1 when the processor 50 runs an operating system and/or at least one application. In the embodiment of FIG. 5, the background service 21 is executed by the processor 50. Moreover, the program 40 may be executed by the processor 50.

According to the above embodiments, before launch of an application to be run by the processor 10 is performed, the background service 21 prepares the memory space of the volatile memory 13 which is sufficient to finish launching the application through reclaiming the volatile memory 13. Thus, the launch of the application may not be interrupted for asking more available space of the volatile memory 13, which results in short launch time and improve user experience.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A launch method for a first application on an electronic device when a launch program is loaded and executed by a first processor, comprising:
receiving a signal indicating that the first application is to be launched;
notifying a background service to prepare memory space of a first memory for launch of the first application in response to the received signal; and
launching the first application after notifying the background service to prepare the memory space of the first memory.

2. The launch method as claimed in claim 1 further comprising:
preparing the memory space of the first memory for the launch of the first application by the background service.

3. The launch method as claimed in claim 2, the step of preparing the memory space of the first memory for the launch of the first application by the background service comprising:
determining whether available space of the first memory is sufficient to finish launching the first application; and
when the available space is not sufficient to finish launching the first application, freeing occupied space of the first memory to obtain the memory space of the first memory.

4. The launch method as claimed in claim 3, wherein the step of freeing occupied space of the first memory to obtain the memory space of the first memory comprises:
moving data stored in the first memory for a second application into a second memory.

5. The launch method as claimed in claim 3, wherein the step of freeing occupied space of the first memory to obtain the memory space of the first memory comprises:
discarding data stored in the first memory for a second application.

6. The launch method as claimed in claim 3, wherein the step of freeing occupied space of the first memory to obtain the memory space of the first memory comprises:
ending a second application which is running on the first processor.

7. The launch method as claimed in claim 6, wherein the second application has a lower priority value among other application running on the first processor.

8. The launch method as claimed in claim 1, further comprising:
calculating usage space of the first memory which is used for launch of the first application,
updating history data for the launch of the first application according to the calculated usage space.
wherein the memory space is prepared according to the history data.

9. The launch method as claimed in claim 1, wherein the background service is executed by a second processor different from the first processor.

10. An electronic device comprising:
a first memory;
a first memory controller coupled to the first memory;
a first processor executing the launch program to receive a signal indicating that a first application is to be launched, notify a background service to prepare memory space of the first memory for launch of the first application in notifying the background service to prepare the memory space of the first memory.

11. The electronic device as claimed in claim 10, wherein the background service is executed to determine whether available space of the first memory is sufficient to finish launching the first application and control the first memory controller to free occupied space of the first memory to obtain the memory space of the first memory when the available space is not sufficient to finish launching the first application.

12. The electronic device as claimed in claim 11, further comprising:
a second memory; and
a second memory controller controlled to the second memory,
wherein the background service is executed to control the first memory controller to read data stored in the first memory for a second application and control the second memory controller to write the data read from the first memory into the second memory to obtain the memory space of the first memory.

13. The electronic device as claimed in claim 11, wherein the background service is executed to end a second application which is running on the first processor.

14. The electronic device as claimed in claim 13, wherein the second application has a low priority value.

15. The electronic device as claimed in claim 10, wherein the first processor calculates usage space of the first memory which is used for the launch of the first application and updates history data for the launch of the first application according to the calculated usage space, and the background service is executed to prepare the memory space according to the history data.

16. The electronic device as claimed in claim 10, further comprising:
a second processor executing the background service.

17. A launch method for an application on an electronic device when a launch program is loaded and executed by a first processor, comprising:
notifying a background service to prepare memory space of a memory for launch of the application;
launching the application by accessing the prepared memory space of the memory;
obtaining space of the memory occupied for the launch of the application; and
updating history usage space for the launch of the application according to the obtained space of the memory occupied for the launch of the application.

18. The launch method as claimed in claim 17, further comprising:
querying the space of the memory occupied for the launch of the application from an operating system performed by the first processor.

19. The launch method as claimed in claim 18, further comprising:
determining whether the available space of the memory is less than the history usage space by the background service before the launch of the application; and
when the available space of the memory is less than the history usage space, freeing occupied space of the memory to prepare the memory space of the memory by the background service.

20. The launch method as claimed in claim 18, wherein the background service is executed by a second processor different from the first processor.
